(19) United States
(12) Patent Application Publication
(10) Pub. No.: US 2018/0188143 A1
(43) Pub. Date: Jul. 5, 2018

(54) APPARATUS FOR USE WITH PARTICULATE FLUID SAMPLE

(71) Applicants: George BOTOS, Oakville (CA); Shazia TANVIR, Waterloo (CA)

(72) Inventors: George BOTOS, Oakville (CA); Shazia TANVIR, Waterloo (CA)

(21) Appl. No.: 15/740,153

(22) PCT Filed: Jun. 29, 2016
(86) PCT No.: PCT/CA2016/050763

§ 371 Date: Dec. 27, 2017

Related U.S. Application Data
(60) Provisional application No. 62/185,973, filed on Jun. 29, 2015.

(51) Int. Cl. G01N 1/40; G01F 19/00; B01D 29/96; B01D 29/085; G01N 1/34

(52) U.S. Cl. CPC G01N 1/4077; G01F 19/00; B01D 29/96; G01N 2001/4016; G01N 1/34; G01N 2001/4088; B01D 29/085

(57) ABSTRACT

An apparatus for use with a particulate fluid sample such as a bacterial fluid sample. The apparatus includes a sample receiver assembly, a particulate removal assembly and a fluid moving assembly. The particulate fluid sample can include bacteria in water. The particulate removal assembly is configured to filter out the particulates. The amount of bacteria filtered out may be measured. The apparatus concentrates the particulate matter to a measurable level by removing fluid from the s.

### TECHNICAL FIELD

This document relates to the technical field of (and is not limited to) an apparatus for use with a particulate (such as, a bacterial fluid sample), and method therefor.

### BACKGROUND

Specimen collection systems for collecting bacteria are known.

### SUMMARY

It will be appreciated that there exists a need to mitigate (at least in part) at least one problem associated with the existing specimen collection systems for collecting bacteria (also called the existing technology). After much study of the known systems and methods with experimentation, an understanding of the problem and its solution has been identified and is articulated as follows:

To mitigate, at least in part, at least one problem associated with the existing technology, there is provided (in accordance with a major aspect) an apparatus. The apparatus is for use with a particulate fluid sample. The apparatus includes a sample-receiver assembly configured to receive, at least in part, by the particulate fluid sample. A particulate-removal assembly is configured to be operatively received, at least in part, in the sample-receiver assembly. A fluid-moving assembly is configured to be received, at least in part, by the sample-receiver assembly. This is done in such a way that the fluid-moving assembly moves the particulate fluid sample, at least in part, through the particulate-removal assembly.

To mitigate, at least in part, at least one problem associated with the existing technology, there is provided (in accordance with a major aspect) a method. The method is usable (used) for processing the particulate fluid sample. The method includes the steps of (operations for): (A) receiving at least in part, the particulate fluid sample in a sample-receiver assembly; (B) receiving, at least in part, a particulate-removal assembly in the sample-receiver assembly; and (C) receiving, at least in part, a fluid-moving assembly in the sample-receiver assembly in such a way that the fluid-moving assembly moves the particulate fluid sample, at least in part, through the particulate-removal assembly.

Other aspects are identified in the claims.

Other aspects and features of the non-limiting embodiments may now become apparent to those skilled in the art upon review of the following detailed description of the non-limiting embodiments with the accompanying drawings.

### DETAILED DESCRIPTION OF THE DRAWINGS

The non-limiting embodiments may be more fully appreciated by reference to the following detailed description of the non-limiting embodiments when taken in conjunction with the accompanying drawings, in which:

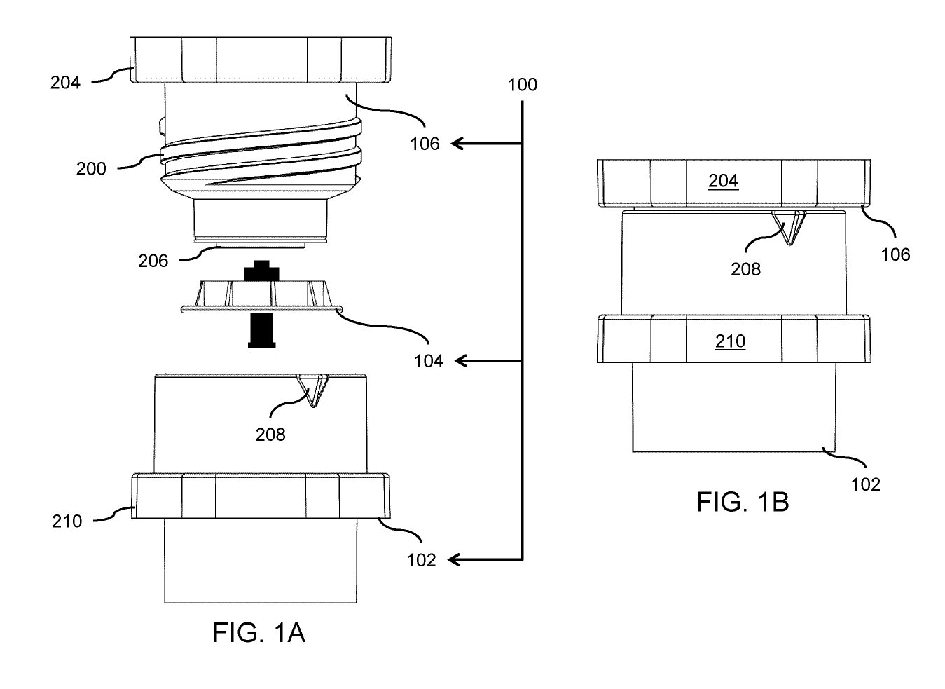

FIG. 1A and FIG. 1B (SHEET 1 of 12 SHEETS) depict side views of embodiments of an apparatus;

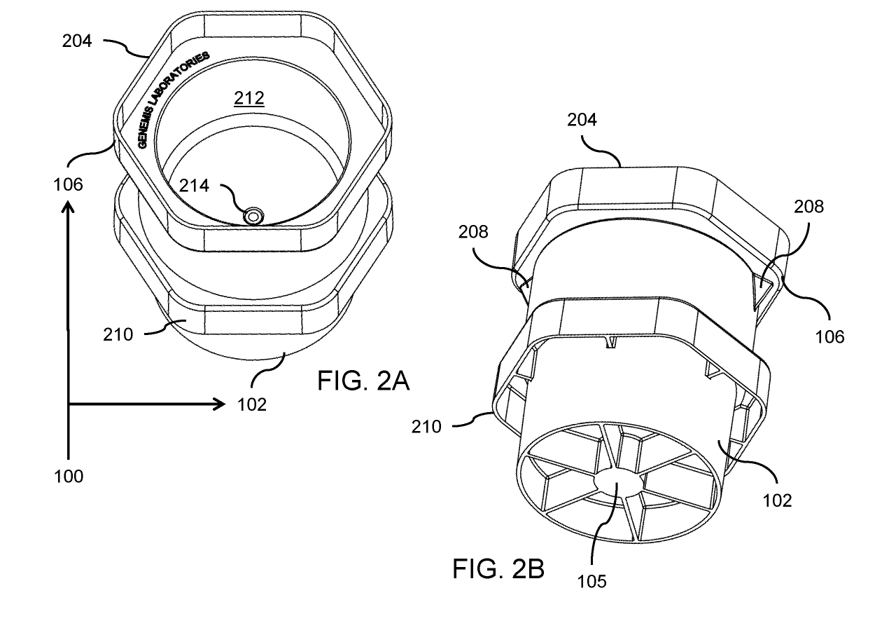

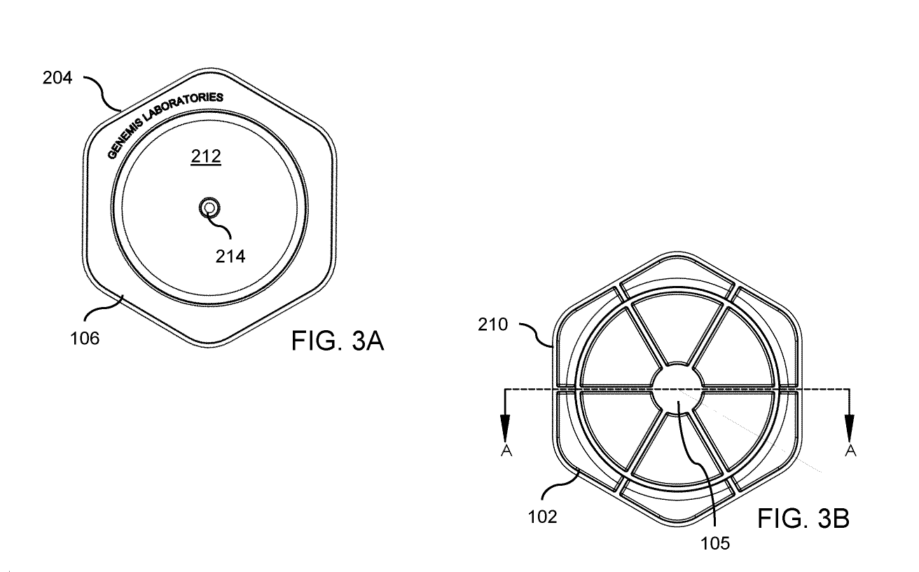

FIG. 2A and FIG. 2B (SHEET 2 of 12 SHEETS) depict perspective views of embodiments of the apparatus of FIG. 1A;

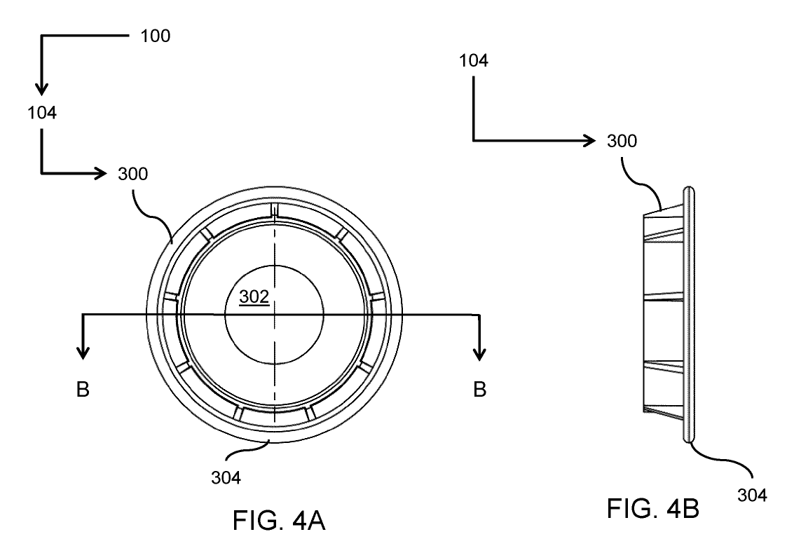

FIG. 3A and FIG. 3B (SHEET 3 of 12 SHEETS) depict end views of embodiments of the apparatus of FIG. 1A;

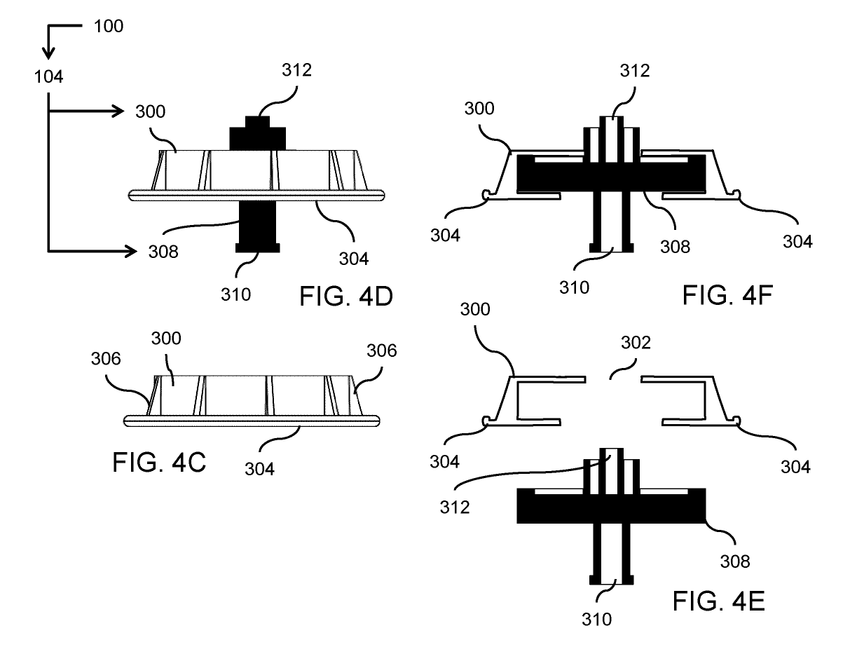

FIG. 4A, FIG. 4B, FIG. 4C, FIG. 4D, FIG. 4E and FIG. 4F (SHEETS 4 and 5 of 12 SHEETS) depict views of embodiments of the apparatus of FIG. 1A;

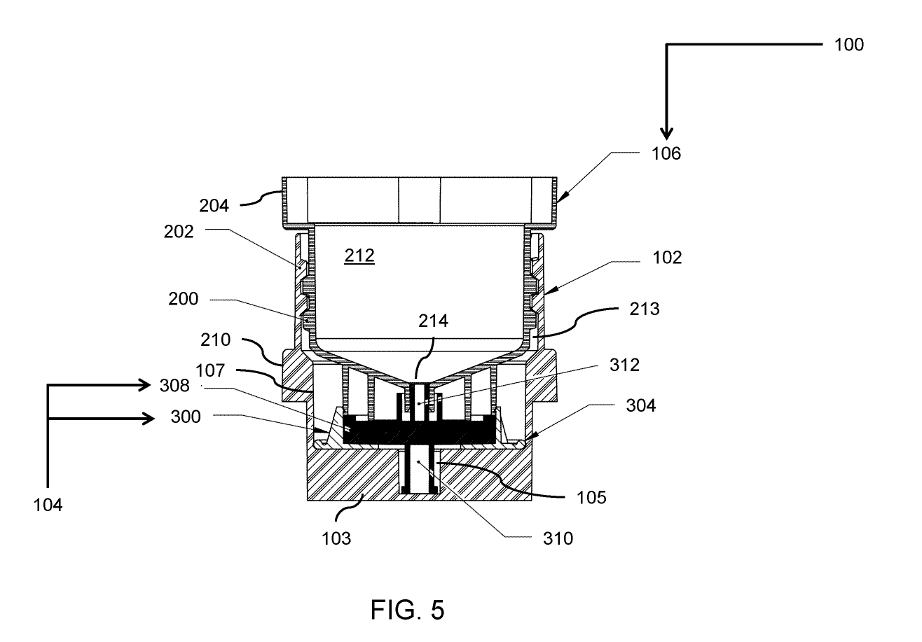

FIG. 5 (SHEET 6 of 12 SHEETS) depicts a cross-sectional view of an embodiment of the apparatus of FIG. 1A; and

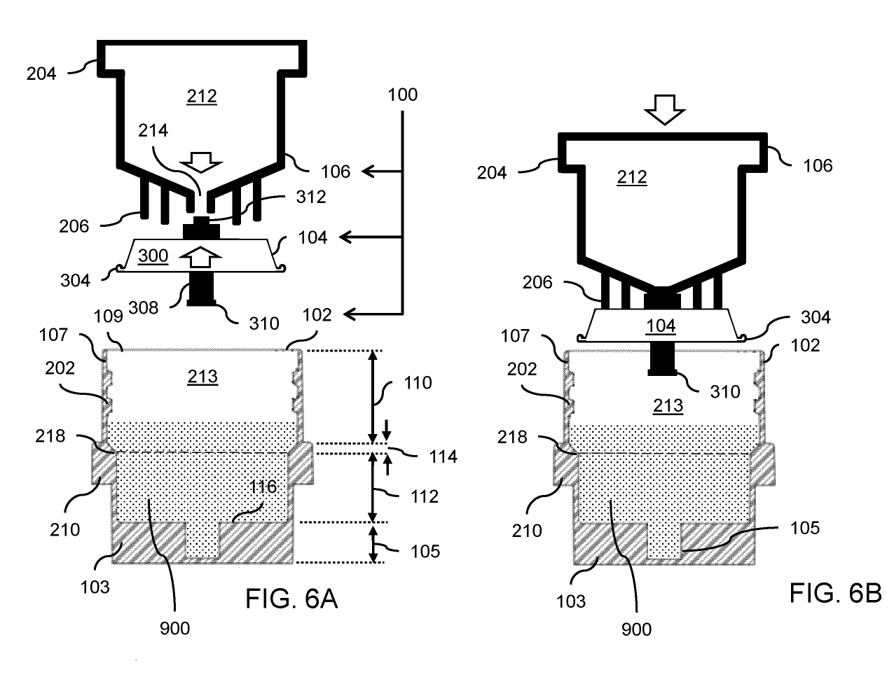

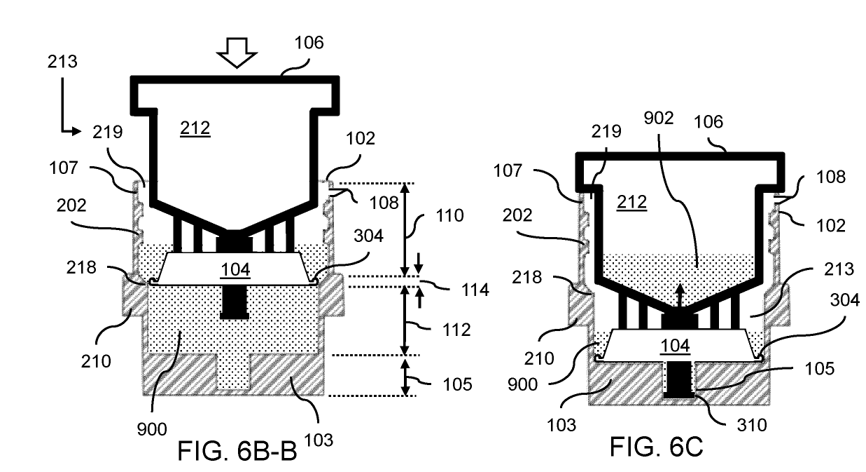

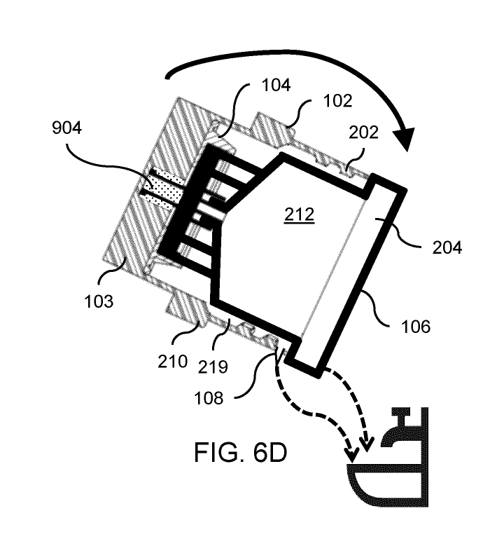

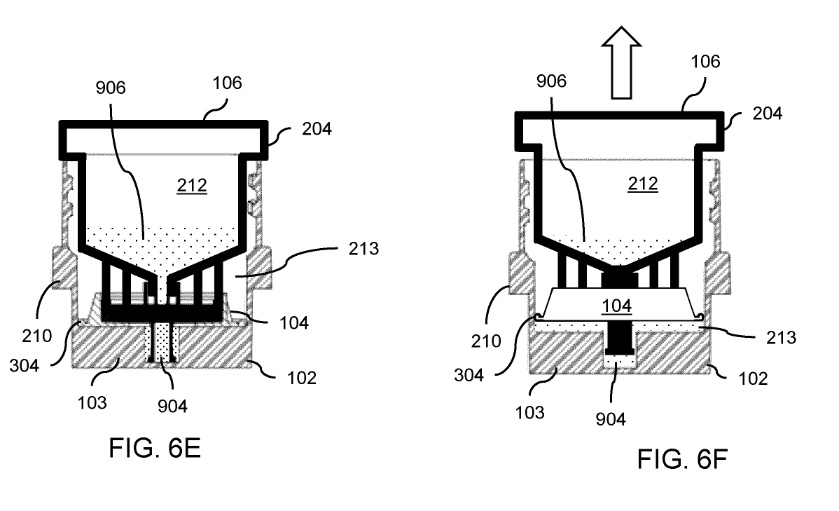

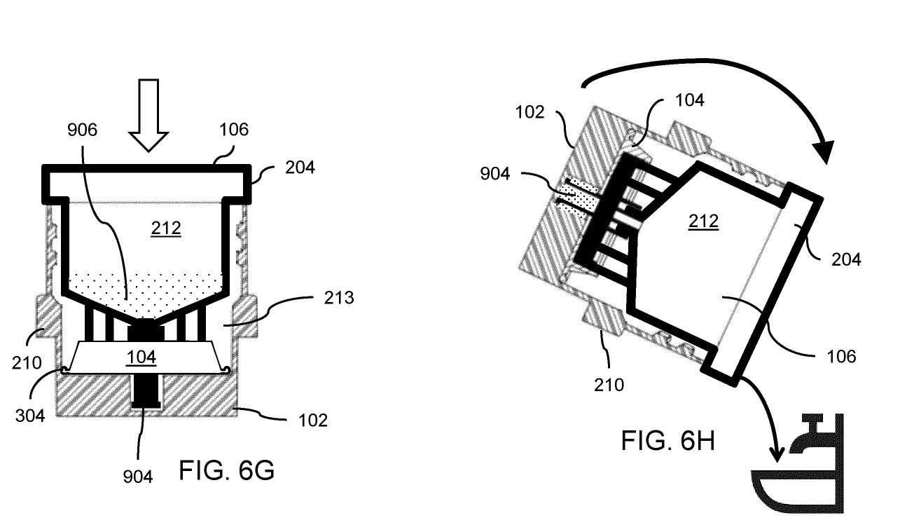

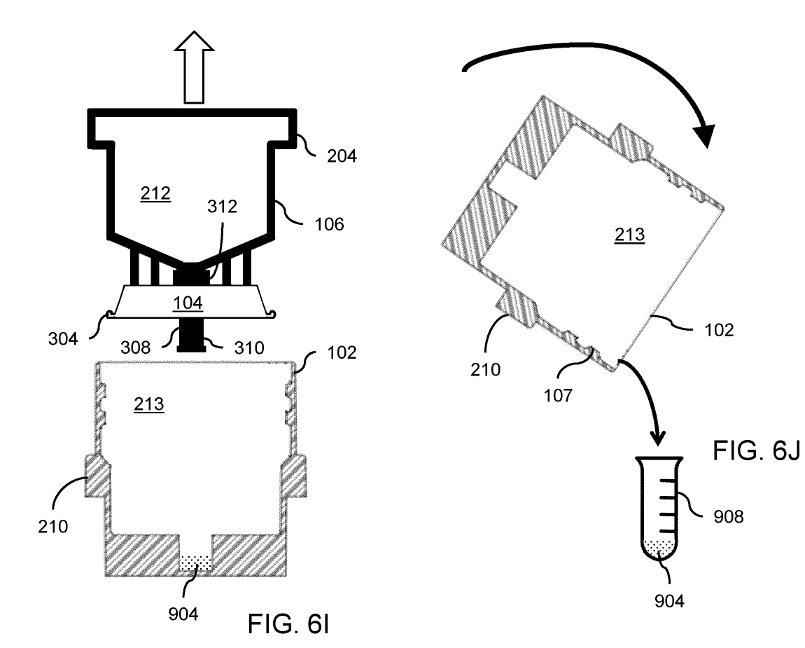

FIG. 6A, FIG. 6B, FIG. 6BB, FIG. 6C, FIG. 6D, FIG. 6E, FIG. 6F, FIG. 6G, FIG. 6H, FIG. 6I and FIG. 6J (SHEETS 7 to 12 of 12 SHEETS) depict views of embodiments of the apparatus of FIG. 1A.

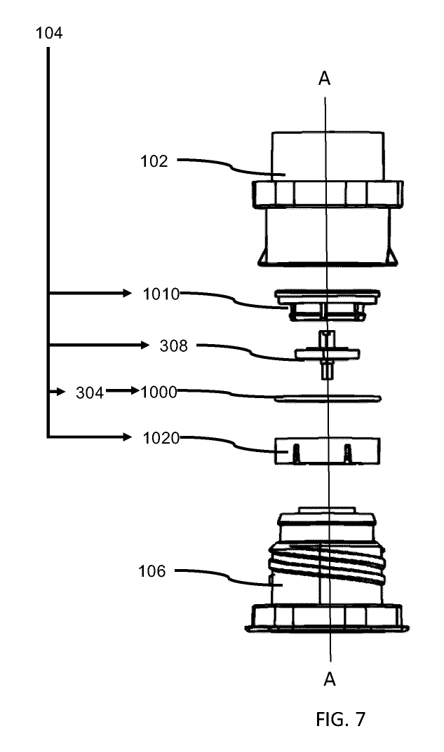

FIG. 7 depicts an expanded side view of an alternate embodiment of an apparatus.

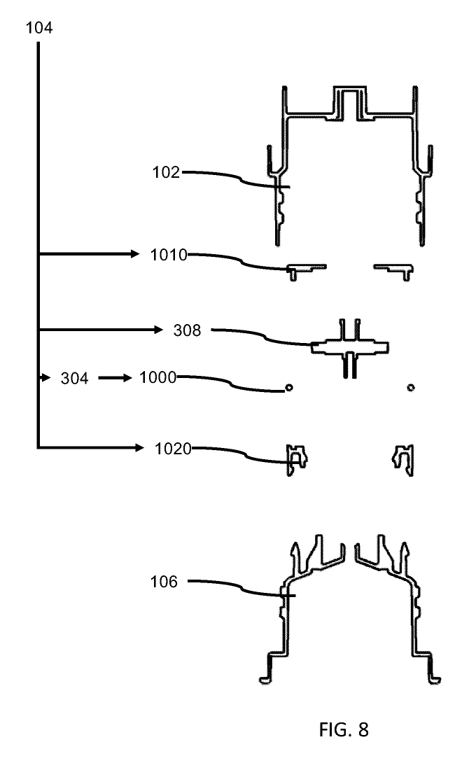

FIG. 8 depicts an expanded cross-sectional side view of the alternate embodiment of FIG. 7 along a plane marked A-A in FIG. 7.

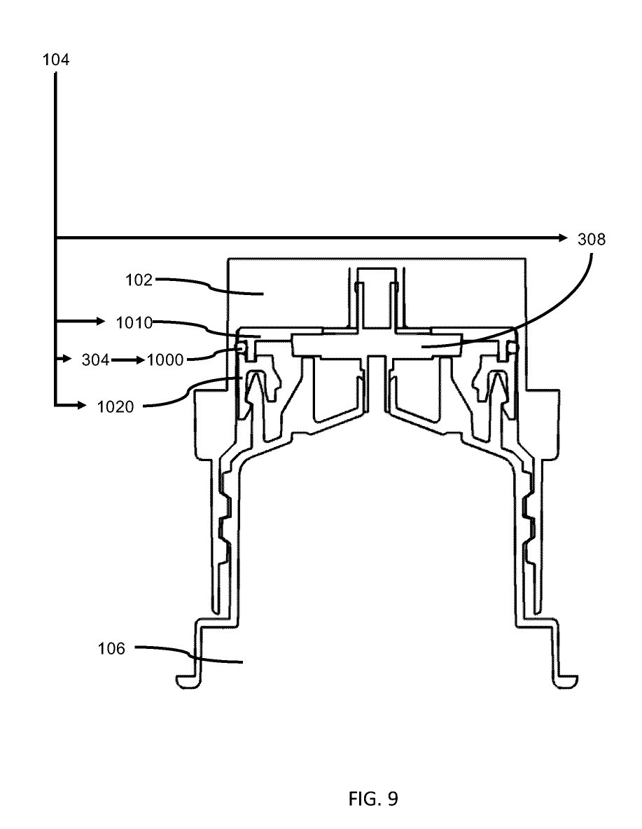

FIG. 9 depicts a cross-sectional side view of the alternate embodiment of the apparatus in its assembled form

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 sample-receiver assembly
103 floor section
104 particulate-removal assembly
105 sample-receiving space
106 fluid-moving assembly
107 inner sidewall
108 spouts
109 chamber entrance
110 first chamber section
112 second chamber section
114 transition section
116 step ledge
200 outer threads
202 interior threads
204 handle section
206 distal end
208 spout
210 handle portion
212 fluid-receiving chamber
213 sampling chamber
214 chamber orifice
218 calibrated level marker
219 space
300 housing assembly
302 housing entrance
304 wiper assembly
306 spaced-apart ribs
308 filter media
310 filter input
312 filter output
400 to 414 operation
900 particulate fluid sample
902 filtered fluid sample
904 concentrated particulate fluid sample
906 wash agent
908 test tube
1000 O-ring
1010 filter media holder
1020 O-ring holder

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

FIG. 1A and FIG. 1B depict side views of embodiments of an apparatus 100. FIG. 1A depicts an exploded side view. FIG. 1B depicts an assembled side view.

The apparatus 100 is for use with a particulate fluid sample 900 (depicted in FIG. 6A). The particulate fluid sample 900 includes an amount of water and an amount of particulates suspended (contained) in the water. The particulates have a physical dimension or physical size (such as, a diameter). For instance, the apparatus 100 is configured to remove or separate (at least in part) some or all of the particulates from the particulate fluid sample 900. For instance, the apparatus 100 includes a particulate-removal assembly 104 configured to filter out (remove or separate, at least in part, some or all of the particulates from the particulate fluid sample 900). The particulate-removal assembly 104 may be called a filter assembly or a particulate-filter assembly, etc. Once the amount of particulates are (physically) filtered (removed or separated) from some of the water (contained in the particulate fluid sample 900), the amount of separated particulates (such as, bacteria) may be measured or quantified (by known measuring equipment not described here).

In accordance with an embodiment, the particulate contained in the particulate fluid sample 900 includes an amount of bacteria to be filtered (removed or separated) from the particulate fluid sample 900. The amount of bacteria that was filtered out may then be measured (by known equipment not discussed here). For instance, the particulate fluid sample 900 includes a sample (a volume) of tap water having bacteria (unwanted bacteria) as the particulate to be removed (filtered). For some cases, the amount of the particulate (bacteria) is to be measured (in colony forming units per millilitre (ml), etc.).

The apparatus 100 is configured to reduce or remove an amount of (volume, weight, etc.) of water (contained in the particulate fluid sample 900) and to substantially maintain the amount (the volume, weight, etc.) of the bacteria contained in the particulate fluid sample 900 regardless of the amount of water that was removed from the particulate fluid sample 900. In effect, the apparatus 100 concentrates the amount of the bacteria by removing water from the particulate fluid sample 900.

Some known measuring systems configured to measure the amount of bacteria contained in the particulate fluid sample 900 are not sensitive enough to obtain an accurate reading of the bacterial concentration (measured in parts per million or ppm) associated with the particulate fluid sample 900.

The apparatus 100 is configured to remove the amount of water from the particulate fluid sample 900 while substantially maintaining the amount of bacteria held in the particulate fluid sample 900. In effect, once the apparatus 100 has removed the amount of water, there is more bacteria per unit of water and, in this manner, the concentration of the bacteria has increased to the point where the known measuring systems are able to accurately measure the bacterial concentration. A calculation is performed on the measured bacterial concentration to take the initial volume of the particulate fluid sample 900 into account, in order to identify the correct bacterial concentration associated with the particulate fluid sample 900.

In accordance with an embodiment, the apparatus 100 includes a synergistic combination of a sample-receiver assembly 102, a particulate-removal assembly 104 and a fluid-moving assembly 106. The sample-receiver assembly 102 is configured to receive, at least in part, by the particulate fluid sample 900. The particulate-removal assembly 104 is configured to be operatively received, at least in part, in the sample-receiver assembly 102. The fluid-moving assembly 106 is configured to be received, at least in part, by the sample-receiver assembly 102. This is done in such a way that the fluid-moving assembly 106 moves the particulate fluid sample 900, at least in part, through the particulate-removal assembly 104.

In accordance with an embodiment, a method is usable for processing the particulate fluid sample 900. The method includes the steps of (operations for): (A) receiving, at least in part, the particulate fluid sample 900 in a sample-receiver assembly 102; (B) receiving, at least in part, a particulate-removal assembly 104 in the sample-receiver assembly 102; and (C) receiving, at least in part, a fluid-moving assembly 106 in the sample-receiver assembly 102 in such a way that the fluid-moving assembly 106 moves the particulate fluid sample 900, at least in part, through the particulate-removal assembly 104.

Referring to the embodiment as depicted in FIG. 1A, the fluid-moving assembly 106 includes (provides) outer threads 200 (also called plunger threads) configured to thread connect with the interior threads 202 (as depicted in FIG. 5) provided by the sample-receiver assembly 102. The fluid-moving assembly 106 includes a handle section 204 positioned at an end section of the fluid-moving assembly 106. The handle section 204 extends along an external surface of the fluid-moving assembly 106. The fluid-moving assembly 106 is configured to be received in and removed from the sample-receiver assembly 102.

The particulate-removal assembly 104 is configured to be connected to the fluid-moving assembly 106 (at a distal end 206 of the fluid-moving assembly 106).

The sample-receiver assembly 102 is configured to receive the particulate fluid sample 900 (as depicted in FIG. 6A). The sample-receiver assembly 102 includes (defines) a spout 208 configured to ease movement of fluid from the interior of the sample-receiver assembly 102 to the exterior of the sample-receiver assembly 102. The sample-receiver assembly 102 includes (defines) a handle portion 210. The handle portion 210 extends along an external surface of the sample-receiver assembly 102.

FIG. 2A and FIG. 2B depict perspective views of embodiments of the apparatus 100 of FIG. 1A.

Referring to the embodiment as depicted in FIG. 2A, the fluid-moving assembly 106 provides (defines) a fluid-receiving chamber 212 surrounded by a sidewall (preferably a circular-shaped sidewall). The fluid-receiving chamber 212 forms a cylindrical shape (an elongated cylindrical shape).

The fluid-moving assembly 106 provides (defines) a chamber orifice 214 positioned at the bottom of the fluid-receiving chamber 212. The chamber orifice 214 is configured to be in fluid communication with the particulate-removal assembly 104 (as depicted in FIG. 5) once the particulate-removal assembly 104 is operatively connected (affixed) to the fluid-moving assembly 106.

The sample-receiving space 105 is positioned at a lower central section of the sample-receiver assembly 102.

FIG. 3A and FIG. 3B depict end views of embodiments of the apparatus 100 of FIG. 1A. FIG. 3A depicts an end view of an embodiment of the fluid-moving assembly 106. FIG. 3B depicts an end view of an embodiment of the sample-receiver assembly 102.

The handle section 204 defines an octagonal-shaped perimeter band. The handle portion 210 defines an octagonal-shaped perimeter band.

FIG. 4A, FIG. 4B, FIG. 4C, FIG. 4D, FIG. 4E and FIG. 4F depict views of embodiments of the apparatus 100 of FIG. 1A. FIG. 4A depicts a top view of an embodiment of the particulate-removal assembly 104. FIGS. 4B to 4D depict side views (edge views) of embodiments of the particulate-removal assembly 104. FIGS. 4E and 4F depict cross-sectional views of embodiments of the particulate-removal assembly 104 (through the cross-sectional line B-B of FIG. 4A).

Referring to the embodiments as depicted in FIG. 4A and FIG. 4B, the particulate-removal assembly 104 includes a housing assembly 300. The housing assembly 300 is configured to be disk shaped.

The housing assembly 300 forms a housing entrance 302.

A wiper assembly 304 is positioned on an outer peripheral edge of the housing assembly 300. Spaced-apart ribs 306 are positioned on the housing assembly 300, and the spaced-apart ribs 306 connect the wiper assembly 304 to the housing assembly 300 in such a way that the spaced-apart ribs 306 provide structural support for the wiper assembly 304.

Referring to the embodiment as depicted in FIG. 4C, FIG. 4D, FIG. 4E and FIG. 4F, the particulate-removal assembly 104 further includes a filter media 308. The filter media 308 is configured to permit passage (flow) of water therethrough. The filter media 308 is configured to block (prevent) flow or movement of bacteria therethrough The filter media 308 forms a disk body having a filter input 310 and a filter output 312. The filter output 312 is paced apart from the filter input 310. The filter input 310 and the filter output 312 are positioned on opposite sides of the filter media 308. An embodiment of the filter media 308 may be manufactured by WHATMAN (specifically, the 25 millimeter outer diameter syringe filter Model Number GD/X). WHATMAN is a GE Healthcare Life Sciences brand specialising in lab filtration products and separation technologies. WHATMAN products cover a range of laboratory applications that require filtration, sample collection (cards and kits), blotting, lateral flow components and flow-through assays and other general laboratory accessories. Formerly WHATMAN PLC, the company was acquired in 2008 by GE Healthcare, a unit of General Electric Company.

FIG. 5 depicts a cross-sectional view of an embodiment of the apparatus 100 of FIG. 1A. FIG. 5 depicts a cross-sectional view of the apparatus 100 taken along the cross-sectional line A-A of FIG. 3B.

Referring to the embodiment as depicted in FIG. 5, the particulate-removal assembly 104 is coupled to the distal end of the fluid-moving assembly 106. The fluid-moving assembly 106 is received in the sample-receiver assembly 102.

Referring to the embodiment as depicted in FIG. 5, the sample-receiver assembly 102 provides (defines) the sampling chamber 213 configured to receive the particulate fluid sample 900. The sample-receiver assembly 102 has a floor section 103 providing (defining) a sample-receiving space 105 configured to receive, at least in part, the particulate fluid sample 900 from the sampling chamber 213. The sample-receiving space 105 and the sampling chamber 213 are coaxially aligned with each other. The sample-receiving space 105 and the sampling chamber 213 are cylindrically shaped.

Referring to the embodiment as depicted in FIG. 5, the particulate-removal assembly 104 is configured to be operatively connected to the fluid-moving assembly 106. The combination of the fluid-moving assembly 106 and the particulate-removal assembly 104 are configured to be operatively received (at least in part) in the sampling chamber 213 of the sample-receiver assembly 102. The particulate-removal assembly 104 is not configured to be received in the sample-receiving space 105.

Referring to the embodiment as depicted in FIG. 5, the particulate-removal assembly 104 is configured to operatively contact an inner sidewall 107 of the sample-receiver assembly 102. The inner sidewall 107 surrounds the sampling chamber 213. Specifically, the wiper assembly 304 of the particulate-removal assembly 104 is configured to wipe the inner sidewall 107 as the wiper assembly 304 is made to move along the inner sidewall 107.

Referring to the embodiment as depicted in FIG. 5 (in accordance with a preferred embodiment), the fluid-moving assembly 106 includes a plunger assembly configured to be received in and removed from the sampling chamber 213 of the sample-receiver assembly 102. The fluid-moving assembly 106 is selectively movable into and out from (relative to) the sampling chamber 213 of the sample-receiver assembly 102.

The apparatus 100 may be called a microbial sample concentrator. The apparatus 100 is configured to filter out excess water (from the particulate fluid sample 900 as depicted in FIG. 6A).

The apparatus 100 is also configured to reduce the overall volume of water in the particulate fluid sample 900.

In accordance with the embodiment as depicted in FIG. 5, the apparatus 100 includes (and is not limited to) a sample-receiver assembly 102. The sample-receiver assembly 102 is configured to receive (collect) the particulate fluid sample 900. The particulate fluid sample 900 may be collected or obtained from a water-sampling location.

The combination of the particulate-removal assembly 104 and the fluid-moving assembly 106 is configured to push excess water (water without the bacteria) through the particulate-removal assembly 104 that is mounted in the fluid-moving assembly 106.

The particulate-removal assembly 104 includes a housing assembly 300. The housing assembly 300 is configured to snap fit to the fluid-moving assembly 106 (to a distal end of the fluid-moving assembly 106).

The housing assembly 300 provides the wiper assembly 304. The wiper assembly 304 is configured to wipe (push) the water in the lower chamber (as depicted in FIG. 6C), and is also configured to force the water to pass through the chamber orifice 214 located in the center of the fluid-moving assembly 106 (depicted in FIG. 6A).

The apparatus 100 is configured to clean a sample (such as the particulate fluid sample 900), concentrate the sample, and/or collect samples. The sample is used for chemical and biochemical tests that are used for quantitation and identification of microorganisms in water, such as ATP testing PCR, or anti body based field or laboratory test procedures. The ATP test is a process of rapidly measuring actively growing microorganisms through detection of adenosine triphosphate, or ATP. The polymerase chain reaction (PCR) is a technology in molecular biology used to amplify a single copy or a few copies of a piece of DNA across several orders of magnitude, generating thousands to millions of copies of a particular DNA sequence.

The apparatus 100 simplifies sample preparation and improves performance of the sample testing by increasing the concentration of target microorganisms and removing interfering substances, such as external ATP and ADP (for ATP testing) and DNA and RNA free fragments in the sample for PCR and antibody-based testing. Adenosine triphosphate (ATP) is a nucleoside triphosphate used in cells as a coenzyme, often called the “molecular unit of currency” of intracellular energy transfer. Adenosine diphosphate (ADP) (Adenosine pyrophosphate (APP)) is an important organic compound in metabolism and is essential to the flow of energy in living cells. Deoxyribonucleic acid (DNA) is a molecule that carries most of the genetic instructions used in the development and functioning of all known living organisms and many viruses. DNA is a nucleic acid; alongside proteins and carbohydrates, nucleic acids compose the three major macromolecules essential for all known forms of life. Ribonucleic acid (RNA) is a polymeric molecule implicated in various biological roles in coding, decoding, regulation, and expression of genes. RNA and DNA are nucleic acids, and, along with proteins and carbohydrates, constitute the three major macromolecules essential for all known forms of life.

The apparatus 100 also facilitates washing of the sample for tests where chemicals that may be present in the water (such as, chlorine, bicarbonates or other inorganic salts, etc.) may result in a false positive or false negative result, etc.

The following describe some of the technical advantages of the embodiments of the apparatus 100:

Technical advantage (A): the apparatus 100 provides, at least in part, an in-the-field solution for concentrating microorganisms in a water sample;

Technical advantage (B): the apparatus 100 helps to ensure (at least in part) that the concentration ratio (the initial amount to concentrated amount ratio) is always (nearly always) the same (close enough within an acceptable tolerance);

Technical advantage (C): the apparatus 100 helps to ensure (at least in part) that the amount of the filtered fluid (water) is always the same (close enough within an acceptable tolerance); for the case where the sample-receiver assembly 102 is filled above the calibrated level marker 218 (as depicted in FIG. 6A) positioned inside the sampling chamber 213, the amount of the particulate fluid sample 900 may be treated as the first calibration size, and any excess amount of the particulate fluid sample 900 (positioned above the calibrated level marker 218) may be eliminated (removed) through the fluid-receiving chamber 212 (of the fluid-moving assembly 106) to allow relatively easier passage (flow of excess fluid without the particulate or bacteria) or via a transfer space 219 (flow of excess fluid with particulate). The transfer space 219 is positioned between the interior threads 202 of the sample-receiver assembly 102 and the exterior threads of the fluid-moving assembly 106);

Technical advantage (D): the apparatus 100 ensures (at least in part) microorganism recovery from the sample-receiving space 105 (also called, the syringe filter dead space or the space inside the filter);

Technical advantage (E): the apparatus 100 allows (at least in part) sample washing to eliminate (reduce at least in part) chemical contaminants that may interfere with the test results;

Technical advantage (F): the apparatus 100 may be used in a disposable (single use) mode, where the entire instance of the apparatus 100 is used once and disposed;

Technical advantage (G): the apparatus 100 may be used as a reusable design; when the apparatus 100 is made of steam-resistant plastics, the apparatus 100 may be re-used multiple times by disassembling and washing the apparatus 100, sterilizing the apparatus 100, and replacing the particulate-removal assembly 104 and housing assembly 300 with unused instances of the particulate-removal assembly 104 for each filtration;

Technical advantage (H): the apparatus 100 allows (at least in part) for testing for the interference of the chemical in the water by testing the water collected in the fluid-receiving chamber 212 of the fluid-moving assembly 106 after filtration, thus allowing for an internal control of the testing procedure; and

Technical advantage (I): the apparatus 100 allows (at least in part) for the use of various pore size filters (from about 0.2 micron, about 0.45 microns, about 5 microns or any other size available) depending on the target organism (bacteria) that needs to be concentrated in the apparatus 100 (also for size exclusion if desired). For the case where there is a need to collect a parasite cyst, such as giardia (which have a size of about 8 microns to about 14 microns in diameter) and there is a need to not collect bacteria, a filter media 308 having about a 5 micron dimensioned pore size may be used. For the case where it is required to test for all microorganisms, the filter media 308 having about a 0.2 micron pore size may be used (etc.). The apparatus 100 may also allow to fraction (divide) the sample base on the size of the microorganism and eliminate large organic contaminants such as pieces of biofilm (or a larger multicellular organisms) suspended in the particulate fluid sample 900, by using the largest size filter media first, and then use the fluid collected in the fluid-receiving chamber 212 of the fluid-moving assembly 106 (the upper plunger chamber) for the next test using a smaller size filter media (by replacing or swapping out filters media as needed).

FIG. 6A, FIG. 6B, FIG. 6BB, FIG. 6C, FIG. 6D, FIG. 6E, FIG. 6F, FIG. 6G, FIG. 6H, FIG. 6I and FIG. 6J depict views of embodiments of the apparatus 100 of FIG. 1A.

FIG. 6A depicts the sample-receiver assembly 102 receiving the particulate fluid sample 900 (in the sampling chamber 213). The particulate-removal assembly 104 is attached to the fluid-moving assembly 106.

Referring to the embodiment as depicted in FIG. 6A, the sample-receiver assembly 102 defines (provides) the sampling chamber 213, and a chamber entrance 109 leads into the sampling chamber 213. The chamber entrance 109 is configured to receive the fluid-moving assembly 106 (and the particulate-removal assembly 104 that is attached to the lower section of the particulate-removal assembly 104).

The sampling chamber 213 includes (is partitioned into) a first chamber section 110, a second chamber section 112, a transition section 114 (also called a tapered section) and a sample-receiving space 105. The second chamber section 112 has the floor section 103, and the sample-receiving space 105 is defined in the floor section 103. The floor section 103 is configured to contact (at least in part) the bottom section of the housing assembly 300 of the particulate-removal assembly 104 (as depicted in FIG. 6C). The first chamber section 110, the second chamber section 112 and the sample-receiving space 105 are (preferably) cylindrically shaped. The first chamber section 110, the second chamber section 112, the transition section 114 and the sample-receiving space 105 are aligned coaxially with each other (preferably, along a stacked vertical arrangement). The chamber entrance 109 fluidly leads into the first chamber section 110. The first chamber section 110 fluidly leads into the transition section 114. The transition section 114 fluidly leads into the second chamber section 112. The second chamber section 112 fluidly leads into the sample-receiving space 105. A step ledge 116 is positioned between the second chamber section 112 and the sample-receiving space 105. The step ledge 116 forms a flat surface. The step ledge 116 is configured to be contacted by the bottom edge section of the housing assembly 300 of the particulate-removal assembly 104 (once the particulate-removal assembly 104 is operatively received in the second chamber section 112, as depicted in FIG. 6C). The diameter of the first chamber section 110 is greater than the diameter of the second chamber section 112. The diameter of the first chamber section 110 is greater than to the diameter of the wiper assembly 304 of the particulate-removal assembly 104. The diameter of the second chamber section 112 is nominally greater than (just slightly) the diameter of the wiper assembly 304 of the particulate-removal assembly 104. The wiper assembly 304 is configured to contactably wipe the inside surface of the second chamber section 112 (once the wiper assembly 304 is moved into and along the second chamber section 112 just so). The filter input 310 of the particulate-removal assembly 104 is configured to be slidably received in the sample-receiving space 105. The diameter of the sample-receiving space 105 is slightly greater than the diameter of the filter media 308 (that is, just enough to allow sliding contact fit between the filter media 308 and the sample-receiving space 105).

The amount of fluid received in the second chamber section 112 and the sample-receiving space 105 (that is, the amount of fluid received below the calibrated level marker 218) is a first calibrated sample size (predetermined volume) of the particulate fluid sample 900 (having an amount of fluid and amount of particulate). The amount of the particulate fluid sample 900 positioned vertically above the calibrated level marker 218 (as depicted in FIG. 6A) is the amount of the particulate fluid sample 900 that will be discarded (as depicted in FIGS. 6C and 6D). The volume contained in the sample-receiving space 105 is a second calibrated sample size (predetermined volume) to be tested (measured) to determine the amount of particulate contained in the first calibrated sample size (since the particulate-removal assembly 104 prevented the particulate to leave the sample-receiving space 105 via the particulate-removal assembly 104).

The fluid-moving assembly 106 is configured to remove (extract) an amount (volume, weight, etc.) of water contained in the particulate fluid sample 900 (from the sampling chamber 213 of the sample-receiver assembly 102 to the fluid-receiving chamber 212 of the fluid-moving assembly 106). Preferably, the particulate-removal assembly 104 is also configured to substantially maintain the amount (volume, weight, etc.) of bacteria contained in the particulate fluid sample 900 (depending on the gauge size of the particulate-removal assembly 104). Preferably, the particulate-removal assembly 104 is configured to: (A) prevent movement of a first range of predetermined sizes of particulate from the sampling chamber 213 (of the sample-receiver assembly 102) to the fluid-receiving chamber 212 (of the fluid-moving assembly 106), and (B) permit movement of a second range of predetermined sizes of particulate from the sampling chamber 213 (of the sample-receiver assembly 102) to the fluid-receiving chamber 212. It will be appreciated that the particulate-removal assembly 104 has an allowable tolerance for preventing movement and allowing movement of particulates (such as, types of bacteria) contained in the particulate fluid sample 900.

FIG. 6B depicts the combination of the particulate-removal assembly 104 and the fluid-moving assembly 106 inserted into the sampling chamber 213 defined or provided by the sample-receiver assembly 102. The particulate-removal assembly 104 leads into the sampling chamber 213, followed by the fluid-moving assembly 106.

FIG. 6BB depicts the case where the wiper assembly 304 of the particulate-removal assembly 104 is positioned proximate to the calibrated level marker 218. The calibrated level marker 218 is the point of contact between the transition section 114 and the second chamber section 112. Once the wiper assembly 304 contacts the calibrated level marker 218, fluid positioned (received) in the second chamber section 112 (below the wiper assembly 304) is pushed (moved), at least in part) through the particulate-removal assembly 104 and into the fluid-receiving chamber 212 of the fluid-moving assembly 106. Once the wiper assembly 304 contacts the calibrated level marker 218, any fluid positioned above the wiper assembly 304 (received in the transition section 114 and/or the first chamber section 110) remains in the first chamber section 110 and/or the transition section 114 (this fluid is to be removed, as depicted in FIG. 6D). ccc

FIG. 6C depicts the wiper assembly 304 and the particulate-removal assembly 104 pushing the particulate fluid sample 900 through the particulate-removal assembly 104. This is done in such a way that the filtered fluid sample 902 moves from the filter media (of the particulate-removal assembly 104) into the fluid-receiving chamber 212 of the fluid-moving assembly 106. Preferably, the filtered fluid sample 902 includes no particulates greater than the size of the filter pores of the particulate-removal assembly 104. The sample-receiving space 105 of the sample-receiver assembly 102 receives a concentrated particulate fluid sample 904 (such as, a concentrated bacterial fluid sample).

FIG. 6D depicts the filtered fluid sample 902 removed from the fluid-receiving chamber 212 of the fluid-moving assembly 106.

FIG. 6E depicts the fluid-receiving chamber 212 receiving an amount of wash agent 906. The wash agent 906 will be used to clean the particulate-removal assembly 104; specifically, wash agent 906 is used (by the apparatus 100) to release the particulates, such as bacteria, that are trapped on the outer surface of the filter media 308 of the particulate-removal assembly 104. This is done in such a way that the trapped particulates may be released from the filter media 308, and the released particulates may move back into the concentrated particulate fluid sample 904.

FIG. 6F depicts the fluid-moving assembly 106 moved away from the sample-receiver assembly 102, causing negative pressure in the sampling chamber 213 of the sample-receiver assembly 102. In this manner, the wash agent 906 is sucked into the sampling chamber 213 via the particulate-removal assembly 104 (in such a way that the particulate-removal assembly 104 is cleaned by forcing the flow of the wash agent 906 through the particulate-removal assembly 104).

FIG. 6G depicts the fluid-moving assembly 106 moved into the sample-receiver assembly 102 in such a way as to force excess water through the particulate-removal assembly 104. The cleaning operation may be performed (reiterated) as often as may be required.

FIG. 6H depicts the wash agent 906 dumped from the fluid-moving assembly 106 into the sink.

FIG. 6I depicts the combination of the fluid-moving assembly 106 and the particulate-removal assembly 104 removed from the interior 213 of the sample-receiver assembly 102.

FIG. 6J depicts the concentrated particulate fluid sample 904 removed from the interior 213 of the sample-receiver assembly 102 to a test tube 908.

The method of using the apparatus 100 includes the following operations:

Operation 400 (as depicted in FIG. 6A) includes collecting (receiving) the particulate fluid sample 900 (to be tested) in the sample-receiver assembly 102. In accordance with the depicted embodiment of FIG. 6A, the amount of the particulate fluid sample 900 extends to at least (or beyond) a calibrated level marker 218 (a level marker or a ridge) placed or positioned in the sampling chamber 213. This operation is used to collect a predetermined volume (that is, the first calibrated volume) of the particulate fluid sample 900 in the sampling chamber 213. For the case where the amount of the particulate fluid sample 900 collected in the sampling chamber 213 (of the sample-receiver assembly 102) does not extend to the calibrated level marker 218, the collected amount of the particulate fluid sample 900 may not allow for a correct determination (measurement) of the particulate concentration ratio (within an allowable level of accuracy and/or precision). For the case where the amount of the particulate fluid sample 900 extends above the calibrated level marker 218, this condition or case does not adversely affect the collection of the amount of particulate (in the sample-receiving space 105) because any excess amount of the particulate fluid sample 900 is to be pushed out (removed) from the sampling chamber 213 to the fluid-receiving chamber 212 (or pushed out via the space 219 (as depicted FIG. 6A). The excess amount of the particulate fluid sample 900 is expelled as the fluid-moving assembly 106 is moved into the sample-receiver assembly 102, such as screwing (threading) the fluid-moving assembly 106 (also called the plunger assembly) to the sample-receiver assembly 102.

Operation 402 (as depicted in FIG. 6B) includes placing (inserting) the fluid-moving assembly 106 in the sample-receiver assembly 102, pushing (moving) the fluid-moving assembly 106 (slowly) until the outer threads 200 (depicted in FIG. 1A) of the fluid-moving assembly 106 line up (align) with the interior threads 202 (as depicted in FIG. 6A) of the sample-receiver assembly 102 (as depicted in FIG. 6B). The operation also includes slowly turning the fluid-moving assembly 106 (preferably, clockwise) with a steady rotation (by applying the required amount of force or torque to cause the fluid-moving assembly 106 to turn or rotate). This operation also includes monitoring the excess water (water that is expelled) coming along the inner sidewall 107 of the sample-receiver assembly 102 and/or the water that collects in the fluid-receiving chamber 212 of the fluid-moving assembly 106.

Operation 404 (as depicted in FIG. 6C) includes stopping any further movement of the fluid-moving assembly 106 once the fluid-moving assembly 106 has reached the floor section 103 of the sample-receiver assembly 102. For the case where a control test is desired or there is an interest for further processing and/or testing of the concentrated particulate fluid sample 904 (also called, the supernatant solution), this operation further includes collecting the filtered fluid sample 902 (the water) received in the fluid-receiving chamber 212 of the fluid-moving assembly 106 for testing (if desired).

Operation 406 (as depicted in FIG. 6D) includes turning the apparatus 100 upside down to remove the filtered fluid sample 902 (any additional excess water) received in the fluid-receiving chamber 212 of the fluid-moving assembly 106 and/or any water (fluid) positioned on the interior threads 202 of the sample-receiver assembly 102.

Operation 408 (as depicted in FIG. 6E and FIG. 6F) includes (for the case where the concentrated particulate fluid sample 904 requires washing to eliminate potential chemical contaminants from the particulate-removal assembly 104) filling the fluid-receiving chamber 212 with an amount of the wash agent 906 (such as, distilled water), and also includes turning the fluid-moving assembly 106 counterclockwise to draw in (force movement of) the wash agent 906 from the fluid-receiving chamber 212 of the sampling chamber 213. This action is used to dilute the concentrated particulate fluid sample 904 (such as, the concentrated microbial suspension) contained in the sampling chamber 213 of the sample-receiver assembly 102. This operation also includes turning the fluid-moving assembly 106 clockwise to eliminate the excess liquid from the interior 213 of the sample-receiver assembly 102. This operation may be repeated as many times as required to reduce and (preferably) eliminate the contaminant contained in the particulate-removal assembly 104 (through repeated dilutions).

Operation 410 includes making sure the fluid-receiving chamber 212 remains empty and contains no liquid, then collecting the residual liquid and particulates (such as, the suspended microorganisms) from the filter dead space associated with the particulate-removal assembly 104 (the space between the filter membrane and the filter output 312, as depicted in FIG. 4E) by turning (rotating or moving) the fluid-moving assembly 106 counterclockwise. Prior to moving the fluid-moving assembly 106, the fluid-receiving chamber 212 remains and stays empty and contains no liquid. A vacuum is created (by this operation) or formed in the sampling chamber 213, and the vacuum is used to extract all or almost all of the residual water and particulates (such as, microorganisms) positioned in (attached to) the particulate-removal assembly 104 and/or stored in the filter dead space of the particulate-removal assembly 104. This operation also includes collecting the particulate into the sample-receiving space 105 (also called the sample receiver space) positioned at the bottom of the sampling chamber 213. In an embodiment, the vacuum or partial vacuum is formed in the space defined by the bottom of the housing assembly 300, and, the portion of the sampling chamber 213 that contains the sample-receiving space 105. In another embodiment, the inner sidewall 107 of the sampling chamber 213 in the second chamber section 112 defines the space in which the vacuum or partial vacuum is formed along with the bottom of the housing assembly 300 and the portion of the sampling chamber 213 that contains the sample-receiving space 105. In an embodiment, a seal is formed by contact or friction between the wiper assembly 304 of the housing assembly 300, and the inner sidewall 107 of sampling chamber 213. In another embodiment, a seal is formed by contact or friction between the wiper assembly 304 of the housing assembly 300, and the inner sidewall 107 of sampling chamber 213 in the second chamber section 112. In another embodiment, the seal is formed by contact between the O-ring 1000 and the inner sidewall 107 of sampling chamber 213. In an embodiment, the O-ring 1000 allows for an improved seal for generating the vacuum or partial vacuum

It will be appreciated that the particulate may accumulate on the outer surface of the filter media 308 as the particulate fluid sample 900 is drawn through the filter input 310 and into the filter media 308. The reverse vacuum (once established as depicted in FIG. 6F) will draw out the particulate from the outer surface of the filter media 308 toward the sample-receiving space 105.

Operation 412 (as depicted in FIG. 61) includes removing the fluid-moving assembly 106 from the sample-receiver assembly 102, and transferring the concentrated particulate fluid sample 904 (the amount of liquid) collected in the sample-receiving space 105 of the sample-receiver assembly 102 (by using one of the spouts 108 as depicted in FIG. 1B to avoid spilling) for further testing, etc. The inner sidewall 107 of the sample-receiver assembly 102 is coated with a hydrophobic layer so that the concentrated particulate fluid sample 904 may be entirely removed from the interior of the sample-receiver assembly 102 (for collection into the test tube 908).

Operation 414 includes, for a reusable system, removing the particulate-removal assembly 104, washing the apparatus 100 using distilled water, and autoclaving (disinfecting) the apparatus 100 before further use.

FIG. 7 depicts an expanded side view of an alternate embodiment of an apparatus.

Referring to the embodiment depicted in FIG. 7, the particulate removal assembly 104 can be disassembled and parts of the particulate removal assembly 104 can be removed or replaced. In the embodiment depicted in FIG. 7, the particulate removal assembly 104 has a filter media 308, a filter media holder 1010, an O-ring holder 1020, and an O-ring 1000. The filter media holder 1010 is operatively connected to the O-ring holder 1020 so that an O-ring 1000 is secured between the O-ring holder 1020 and the filter media holder 1010.

FIG. 8 depicts an expanded cross-sectional side view of the alternate embodiment of FIG. 7 along a plane marked A-A in FIG. 7.

FIG. 9 depicts a cross-sectional side view of the alternate embodiment of the apparatus in its assembled form.

Referring to the embodiment depicted in FIG.8 and FIG. 9, the particulate removal assembly 104 is configured to be operatively connected to, and removably attachable to, the fluid-moving assembly 106. In the example depicted in FIG. 8 and FIG. 9, this is done by way of a snap-fitting. The snap-fitting allows for a particulate removal assembly 104 to be attachable to, and detachable from, the fluid-moving assembly 106. This can allow, by way of an example, different particulate-removal assemblies 104 to be used with the same fluid-moving assembly 106. This can be useful in situations where the apparatus 100 is reusable or if a subsequent filtration with a different particulate-removal assembly 104 is desired.

In the example depicted in FIG. 8 and FIG. 9, the O-ring holder 1020 and the filter media holder 1010 are connected using a snap fitting. The O-ring 1000 is secured in a groove defined by the O-ring holder 1020 and the filter media holder 1010 once they are operatively connected. Once secured in the groove, the O-ring 1000 is configured to operatively contact an inner sidewall 107 of the sample-receiver assembly 102. The O-ring 1000 then serves the same function as the wiper assembly 304. That is, the O-ring 1000 of the particulate-removal assembly 104 is configured to wipe the inner sidewall 107 as the O-ring 1000 is made to move along the inner sidewall 107.

In this example, the O-ring can be replaced once the O-ring holder 1020 and the filter media holder 1010 are disassembled. The O-ring 1000 can then be discarded while the O-ring holder 1020 and the filter media holder 1010 can be reused (after cleaning).

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

1. An apparatus for use with a particulate fluid sample, the apparatus comprising:
a sample-receiver assembly being configured to receive, at least in part, the particulate fluid sample;
a particulate-removal assembly being configured to be operatively received, at least in part, in the sample-receiver assembly; and
a fluid-moving assembly being configured to be received, at least in part, by the sample-receiver assembly in such a way that the fluid-moving assembly moves the particulate fluid sample, at least in part, through the particulate-removal assembly
wherein the particulate fluid sample remaining in the sample-receiver assembly is concentrated once the fluid-moving assembly has moved the particulate fluid sample, at least in part, through the particulate-removal assembly.

2. The apparatus of claim 1, the sample-receiver assembly further comprising a calibration marker to indicate a volume of the particulate fluid sample.

3. The apparatus of claim 1, the apparatus configured to be sterilizable.

4. The apparatus of claim 1, wherein the particulate removal assembly is configured to filter at least one size of microorganism.

5. The apparatus of claim 1, wherein the particulate removal assembly can be replaced.

6. The apparatus of claim 1, wherein the particulate removal assembly can be washed to release particulates from a filter media to the particulate fluid sample.

7. The apparatus of claim 1, wherein once the fluid-moving assembly has moved the particulate fluid sample, at least in part, through the particulate-removal assembly, the fluid-moving assembly can be removed, at least in part, from the sample-receiver assembly to create a vacuum, at least in part, in the sample-receiver assembly that is used draw a gas, a liquid, or both from the fluid-moving assembly to the sample-receiver assembly through the particulate-removal assembly.

8. The apparatus of claim 1, wherein once the fluid-moving assembly has moved the particulate fluid sample, at least in part, through the particulate-removal assembly, the fluid-moving assembly can be removed, at least in part, from the sample-receiver assembly to create a vacuum, at least in part, in the sample-receiver assembly that is used draw any remaining particulate fluid sample, a particulate, or both, in the particulate-removal assembly into the sample-receiver assembly.

9. The apparatus of claim 1, wherein the fluid-moving assembly and the sample-receiver assembly are configured with corresponding threads so that the fluid-moving assembly is twisted, at least in part, into the sample-receiver assembly.

10. The apparatus of claim 1, wherein the particulate removal assembly is removably attached to the fluid-moving assembly.

11. The apparatus of claim 1, wherein the particulate removal assembly comprises a filter media holder, an O-ring holder, a filter media, and an O-ring configured between the filter media holder and the O-ring holder such that the O-ring contacts an inner sidewall of the sample-receiver assembly.

12. The apparatus of claim 9, wherein the O-ring, the filter media, or both, can be replaced.

13. A method for processing a particulate fluid sample, the method comprising:
receiving, at least in part, the particulate fluid sample in a sample-receiver assembly;
receiving, at least in part, a particulate-removal assembly in the sample-receiver assembly; and
receiving, at least in part, a fluid-moving assembly in the sample-receiver assembly in such a way that the fluid-moving assembly moves the particulate fluid sample, at least in part, through the particulate-removal assembly;
wherein the particulate fluid sample remaining in the sample-receiver assembly is concentrated once the fluid-moving assembly has moved the particulate fluid sample, at least in part, through the particulate-removal assembly.

14. The method of claim 11 further comprising:
washing the particulate-removal assembly to release particulates from a filter media to the particulate fluid sample.

15. The method of claim 11 further comprising:
removing at least in part, the fluid-moving assembly from the sample-receiver assembly in such a way as to create a vacuum, at least in part, in the sample-receiver assembly so that a gas, a liquid, or both is drawn from the fluid-moving assembly to the sample-receiver assembly through the particle-removal assembly.

16. The method of claim 11 further comprising:
removing at least in part, the fluid-moving assembly from the sample-receiver assembly in such a way as to create a vacuum, at least in part, in the sample-receiver assembly that is used draw any remaining particulate fluid sample, a particulate, or both, in the particulate-removal assembly into the sample-receiver assembly.

17. The method of claim 11 further comprising:
once the fluid moving assembly has moved, at least in part, the particulate-fluid sample:
removing the fluid-moving assembly from the sample-receiver assembly;
replacing the particulate removal assembly with a second particulate removal assembly; and
diluting the particulate fluid sample remaining in the sample-receiver assembly with a known fluid to create a new particulate-fluid sample in the sample-receiver assembly; and
repeating the steps of claim 11 on the new particulate fluid sample.

18. The method of claim 17, wherein the step of replacing the particulate removal assembly comprises:
detaching the particulate removal assembly from the fluid-moving assembly;
disassembling the particulate removal assembly by detaching a filter media holder from an O-ring holder;
replacing a filter media, an O-ring, or both of the particulate removal assembly;
reassembling the particulate removal assembly by attaching the filter media holder to the O-ring holder.

19. The method of claim 17, wherein the step of replacing the particulate removal assembly comprises:
replacing a filter media of the particulate removal assembly.
